(19) United States
(12) Patent Application Publication
(10) Pub. No.: US 2022/0258434 A1
(43) Pub. Date: Aug. 18, 2022

(54) THIN-WALLED COMPOSITE PRODUCT REINFORCED BY HYBRID YARNS AND METHOD FOR MANUFACTURING SUCH A PRODUCT

(71) Applicant: BCOMP SA, Fribourg (CH)

(72) Inventors: Julien RION, Vuisternens-devant-Romont (CH); Vincent HEY, Fribourg (CH); Reto AEBISCHER, Fribourg (CH)

(21) Appl. No.: 17/627,505

(22) PCT Filed: Jun. 17, 2020
(86) PCT No.: PCT/IB2020/055635

§ 371 Date: Jan. 14, 2022

(30) Foreign Application Priority Data
Jul. 16, 2019 (FR) 1907991

(51) Int. Cl. B29C 70/08; B29C 70/16; B29C 70/44

(52) U.S. Cl. CPC B29C 70/08; B29K 2307/04; B29C 70/44; B29C 70/16

(57) ABSTRACT

A thin-walled organic-matrix composite product reinforced by yarns, the yarns compromising hybrid yarns, the hybrid yarns having a core made of a first material having a density less than 1500 kg/m3 and a cover covering the core, the cover being produced from a second material, the second material being different from the first material and having a longitudinal Young's modulus greater than 25 GPa, and the composite product having at least one ribbed face, the ribs being created at least partially by the hybrid yarns.

### FIELD OF THE INVENTION

The present invention relates to a yarn-reinforced, thin-walled composite product and to the method for manufacturing such a composite product.

Such a composite product forms in particular a portion of an article such as, non-limitingly, an automobile bodywork part, in particular the doors, the top, the hood, the fenders, the spoiler, the front and rear bumpers, the aerodynamic sets, or automobile interior parts, in particular the door covers, the dashboard, the central console, the pillar trims, the trunk trim, the roof, or sporting articles such as a hull of a canoe, kayak or light boat, a seat post, a bicycle saddle, a bicycle frame, a bicycle handlebar, a baseball bat, a paddle, a ski stick or walking stick, or else a furniture element, or aircraft interior parts, in particular the lateral panels, the ceiling panels, the luggage compartments, or aerodynamic parts of light aircraft, in particular the engine cowl, the wheel caps, or any aerodynamic fairing of a mobile machine.

Such a composite product can have a multitude of geometries, including a planar sheet, a non-planar sheet, and in particular a sheet with a convex face and a concave face, or else a corrugated sheet, a three-dimensional hollow shape, and in particular a hollow tube of circular cross section, of polygonal cross section or another shape, and in particular any thin-walled, three-dimensional shell.

### PRIOR ART

There are various arrangements of thin-walled, reinforced composite products, in this instance a composite product having a matrix made of plastics material from among a polymer or a resin and a reinforcement which can in particular be in the form of a preform with yarns. The product has a thin wall, which means that it is generally initially in the form of a sheet or a panel, one of the dimensions of which is much smaller (at least 10 times smaller) than the other two.

Composite materials have been used for more than 40 years, in particular for aeronautics and space applications, mainly because of their high specific mechanical properties. Since then, the field of composite materials research has evolved from the initial search for very high specific properties, dictated by aerospace applications, to the need to retain high properties while reducing the manufacturing time and the production costs, by virtue of automotive applications and other large-scale applications, to the recent inclusion of the need to incorporate additional functionalities in the composite part. In recent years, natural-fiber-based composites have received increasing attention due to increasing environmental awareness. On account of their low cost, low environmental impact and relatively high specific mechanical properties, natural fibers are emerging as a new alternative to glass fibers or carbon fibers as reinforcement in composites.

Document U.S. Pat. No. 6,805,939 provides a thin-walled composite material that contains fibers which are impregnated with plastic, in the form of at least two arrays of parallel fiber cords which extend in different directions and form a band, a mesh or a grid. The fiber bundles may be bundled together, or grouped together in a band. The fibers of a first array are impregnated with much more plastic than the fibers of a second array. The composite material is stiff in the direction of the fibers of the first array and is flexible transversely to this direction. Openings advantageously exist between the fiber bundles.

If it is sought to strengthen the thin-walled product in flexion, but also in compression, it is known to provide projecting reinforcements in the form of a grid or a ribbed array, as in WO2017099585, wherein these ribs are formed above and/or below the base plate by molding.

Certain types of thin-walled composite products are known from document EP2648890, in particular with yarns having a first thickness and yarns having a second thickness greater than the first thickness and which serve as reinforcement, these yarns having the second thickness being composed of twisted plant fibers, this twisting contributing in particular a better compressive strength to these yarns having the second thickness.

There are situations in which this type of composite product exhibits a ratio of the mechanical properties to unit weight and/or cost to unit weight for the same mechanical properties that is not satisfactory for the desired application.

FR3073167A1 provides the production of a composite product which includes a prepreg resulting from asymmetric impregnation of a mesh having plant-fiber-based yarns, by dusting polymer particles on one of the faces of the mesh. What is obtained is a yarn mesh having a polymer covering which is thicker on the upper face of the mesh, these yarns being themselves impregnated with this polymer in their plant-fiber-based central portion.

GB1331431A also discloses a composite product able to use yarns with a fiber core covered with a polymer matrix.

### BRIEF SUMMARY OF THE INVENTION

One object of the present invention is to provide a yarn-reinforced, thin-walled composite product forming a thin-walled composite product which is improved in comparison with the prior art.

Another object is to provide a yarn-reinforced, thin-walled composite product which exhibits an improved ratio of mechanical properties to unit weight.

Another object is to provide a yarn-reinforced, thin-walled composite product which exhibits an improved cost per unit weight for otherwise at least the same mechanical properties.

The composite product according to the invention makes it possible to achieve these aims. The composite product according to the invention is a thin-walled composite product with an organic matrix, the reinforcing yarns of which specifically include hybrid yarns having a core made from a first material having a density of less than 1500 kg/m³ and a covering that overlays the core, the covering being made from a second material, said second material being different than the first material and having a longitudinal Young's modulus (along the axis of the hybrid yarn) of greater than 25 GPa, and said composite product having at least one ribbed face, said ribs being created at least in part by the hybrid yarns.

It will be understood that, according to the invention, the use of hybrid yarns makes it possible for these hybrid yarns to have a core (a center) that is lighter and/or cheaper than the covering of the hybrid yarn, with a covering that has sufficient mechanical properties to allow the hybrid yarn to provide satisfactory mechanical reinforcement to the composite product which contains it at the location of all the ribs or some of the ribs formed on at least one of its faces. The use of these hybrid yarns also makes it possible to optimize both the radial compressive strength necessary to withstand the pressure during implementation and to create ribs, this strength being provided essentially by the core of the yarn, and the longitudinal flexural strength and stiffness of the yarn, this being provided essentially by the covering. A composite product having an organic matrix and stiffened by yarns including hybrid yarns is thus obtained.

According to a first type of possible arrangement according to the invention, said composite product has at least a first layer, said first layer comprising both a first type of yarns (A) having a first thickness and a second type of yarns (B) having a second thickness greater than the first thickness, said second type of yarns (B) being made up of said hybrid yarns. Thus, the ribs result from the overthickness created by the hybrid yarns in relation to the first type of yarns (A) in the first layer, said hybrid yarns being made up of said second type of yarns (B).

According to a second type of possible arrangement according to the invention, said composite product has at least a first layer having a first thickness, said first layer being overlaid with a second layer of yarns, said yarns of the second layer comprising said hybrid yarns, the hybrid yarns being spaced apart so as to create a ribbed surface. In this second layer, according to one possibility, only hybrid yarns are used: the spacing between the hybrid yarns generates at the location of the hybrid yarns an overthickness, in the form of a rib, on the face of the second layer of yarns that faces in the opposite direction to the first layer.

In this second layer, according to another possibility, both hybrid yarns and another type of yarn or else other types of yarn other than hybrid yarns are used. In this instance, various configurations may exist for the formation of ribs on the face of the second layer facing in the opposite direction to the first layer, at least some of the ribs resulting from the overthickness of the hybrid yarns in relation to all or some of the other yarns of the second layer and/or from the spacing between the hybrid yarns. Optionally, other ribs may exist and result from the overthickness of some of the other yarns (and not the hybrid yarns) in relation to some of the other yarns of the second layer and/or from the spacing between some of the other yarns.

According to one possibility of the invention, said hybrid yarns have a second thickness greater than the first thickness of the first layer.

According to one embodiment, the core of the hybrid yarns is formed by plant fibers from among the fibers of the following plants: flax, hemp, sisal, jute, abaca, kenaf, coconut, cotton, nettle, ramie, kapok, abaca, henequen, pineapple, banana plant, palm, wood, these fibers being impregnated with an organic matrix in the form of a polymer.

According to one embodiment, the covering of the hybrid yarns is formed by carbon fibers impregnated with an organic matrix in the form of a polymer.

According to one embodiment of the invention, the organic matrix of the composite product is a matrix of plastics material from among a polymer or a resin, and in particular from among a thermosetting polymer (in particular a resin) and a thermoplastic polymer.

According to one embodiment of the invention, the weight of the hybrid yarn impregnated with the organic matrix is between 500 and 15 000 tex (g/km), preferably between 1000 and 10 000 tex, preferably between 2000 and 8000 tex.

According to one embodiment of the invention, the weight of the hybrid yarn (core and covering) not yet impregnated with the organic matrix is between 200 and 10 000 tex (g/km), preferably between 400 and 6000 tex, preferably between 800 and 5000 tex.

According to one embodiment of the invention, the weight of the covering of the hybrid yarn represents between 10-70% of the weight of the hybrid yarn, preferably between 20-60% of the weight of the hybrid yarn, preferably between 25-50% of the weight of the hybrid yarn, considered before impregnation by the organic matrix. According to this scenario, consequently, the weight of the core represents between 30 and 90% of the weight of the hybrid yarn considered before impregnation by the organic matrix, preferably between 40 and 80% of the weight of the hybrid yarn, preferably between 50 and 75% of the weight of the hybrid yarn, considered before impregnation by the organic matrix.

According to one embodiment of the invention, in each hybrid yarn, the covering is formed by one or more rovings (one or more strands). According to one possibility, this or these roving(s) form(s) an angle of less than 15° with the longitudinal axis of the hybrid yarn, it being possible for this angle to be zero, or to be not zero and in particular to be between 1° and 15°, including equal to these limit values.

The present invention also relates to the method for manufacturing a thin-walled composite product as described above, in which method the following steps are implemented:
manufacturing a preform comprising yarns, said yarns including hybrid yarns, said hybrid yarns having a core made from a first material and a covering that overlays the core, the covering being made from a second material different than the first material,
impregnating said preform with an organic matrix,
applying pressure by way of a membrane or a flexible pad to a relief side of the preform against a mold,
controlling the temperature of the mold so as to solidify said organic matrix, so as to obtain a solidified product in which at least one external face forms ribs created at least in part by said hybrid yarns, wherein said first material has (after impregnation by the organic matrix) a density of less than 1500 kg/m³, and wherein said second material has (after impregnation by the organic matrix) a longitudinal Young's modulus of greater than 25 GPa.

### BRIEF DESCRIPTION OF THE FIGURES

Implementation examples of the invention are specified in the description illustrated by the appended figures in which:

FIG. 1 schematically shows a perspective and partially transparent view of a hybrid yarn used in the composite product according to the invention in FIG. 1a, and according to various structural modalities for the core and the covering in FIGS. 1b to 1d,

FIG. 2 schematically shows a perspective view of a possible arrangement for a nonwoven fabric using hybrid yarns to form a composite product according to the invention,

FIG. 3 schematically shows a perspective view of another possible arrangement for a nonwoven fabric using hybrid yarns to form a composite product according to the invention,

FIG. 4 schematically shows a perspective view of another possible arrangement for a nonwoven fabric using hybrid yarns to form a composite product according to the invention,

FIG. 5 schematically shows a perspective view of another possible arrangement for a nonwoven fabric using hybrid yarns to form a composite product according to the invention,

FIG. 6 schematically shows a perspective view of another possible arrangement for a nonwoven fabric using hybrid yarns to form a composite product according to the invention,

FIG. 7 shows a perspective view of another composite product according to the invention,

FIG. 8 schematically shows certain steps of a treatment and strengthening method for manufacturing ribbed sheets according to the invention,

FIG. 9 shows examples of tubes and sheets forming thin-walled composite products according to the invention and obtained by the manufacturing method according to the invention,

FIG. 10 shows other examples of tubes and sheets forming thin-walled composite products according to the invention and obtained by the manufacturing method according to the invention,

FIG. 11 shows an example of a composite product according to the invention, forming a motor vehicle hood.

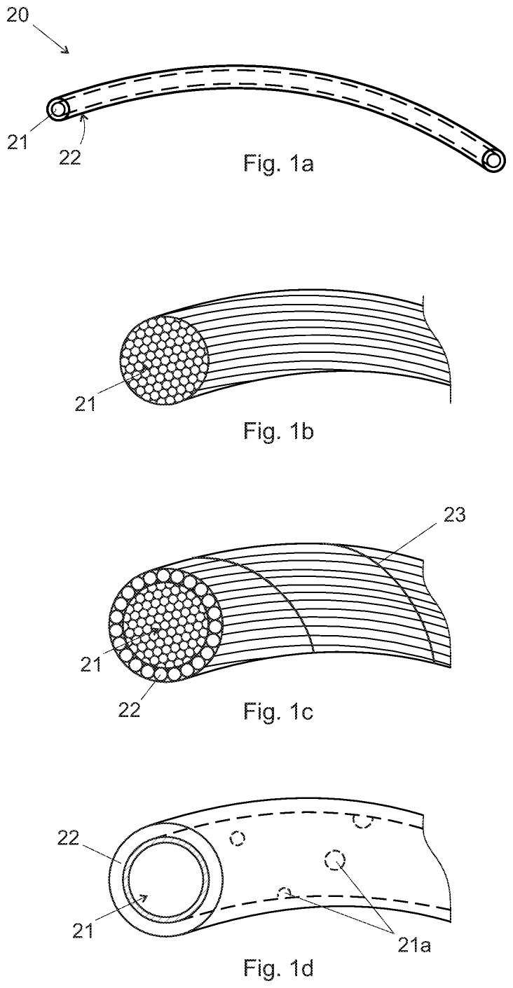

With reference to these drawings, the composite product has hybrid yarns which are shown schematically in FIG. 1a. These hybrid yarns 20 have a core 21 housed in a covering 22. The core 21 is made from a first material different than the second material constituting the covering 22. The hybrid yarns 20 are made up of multiple materials in order to reinforce the mechanical properties of the composite in which they are inserted and thus also reduce its cost and/or its weight. The core 21 of the hybrid yarn 20 is made from a lightweight and inexpensive material with good radial compressive strength, while the outer layer or covering 22 of the hybrid yarn 20 is made from a material which is very strong and stiffer in the longitudinal direction. When this hybrid yarn 20 forms a reinforcement in the form of a raised portion and more specifically of ribs protruding from the surface of the ribbed structure of the composite product, it is a portion of the ribs furthest away from the neutral axis of the hybrid yarn that bears the most loading. Therefore, having a second stiff/strong material on the outer portion of the yarn (the covering 22) very effectively increases the overall flexural properties of the composite structure incorporating the hybrid yarn. Thus, resorting to a less-strong first material for the core 21 does not adversely affect the overall mechanical properties of the composite product reinforced with the hybrid yarns 20.

According to the invention, the first material of the core 21 has a density of less than 1500 kg/m³, or even a density of less than 1350 kg/m³, or even a density of less than 1200 kg/m³ (this density is characterized for this first material in combination with the organic matrix impregnating it). In all cases, this density is greater than 50 kg/m³ and, according to some embodiments, this density is greater than 150 kg/m³ and, in some possible embodiments, this density is greater than 300 kg/m³. As regards the mechanical strength properties of the first material of the core 21, what is not specifically desired, even if it is conceivable, is high mechanical strength characteristics (in particular in tension and in flexion), such that for example a longitudinal Young's modulus of less than 25 GPa is possible (this Young's modulus is characterized for this first material in combination with an organic matrix). By contrast, what is desired is good resistance to radial crushing of the first material (not yet impregnated with the organic matrix) of the core, in order to withstand the pressure during the implementation of the part. It will typically be sought that this first material (taken alone) suffers crushing by less than 50% when pressurized to 6 bar by a plastic film (implementation process in an autoclave).

The second material of the covering 22 has high mechanical strength and stiffness characteristics (in particular in tension and in flexion): thus, according to the invention, the second material has a longitudinal Young's modulus of greater than 25 GPa (this second material for this being characterized when it is impregnated with an organic matrix, and thus forming a composite formed by fibers and an organic matrix, this Young's modulus therefore corresponding to the modulus of this composite of fibers+organic matrix in the direction of the fibers), or even greater than 50 GPa, or even greater than 100 GPa. If reference is made to the characterization of the fibers reinforcing this second material, and therefore not of the composite having an organic matrix incorporating these fibers as reinforcement, as above, these fibers may have a longitudinal Young's modulus of greater than 40 GPa, or even greater than 70 GPa, or even greater than 200 GPa.
The longitudinal Young's modulus is measured by a tensile test, in particular in accordance with the standard DIN EN ISO 527 for plastics and composite materials. In accordance with this standard, what is involved is the modulus of elasticity in tension Eₜ determined by the slope of the stress/strain curve σ(ε) in the interval between the two deformations ε1=0.05% and ε2=0.25%.

These hybrid yarns have two distinct and clearly separately identifiable parts in the form of the core and the covering: this is because the core and the covering are delimited from one another. The first material of the core is different than the second material of the covering. This means that the first material and the second material do not have the same composition, and in most cases that the first material and the second material do not have a common component, namely that the component(s) of the first material is (are) different than the component(s) of the second material.

Various embodiments are possible for such hybrid yarns 20.

According to a first embodiment of the hybrid yarns 20, the core 21 of the hybrid yarn 20 includes or is made up of plant fibers such as fibers obtained from the following plants: flax, hemp, sisal, jute, abaca, kenaf, coconut, cotton, nettle, ramie, kapok, abaca, henequen, pineapple, banana plant, palm, and wood fibers. The core 21 of the hybrid yarn 20 may comprise long fibers or short fibers or both long fibers and short fibers of one from among this list of plants or multiple ones from among this list of plants. The core 21 of the hybrid yarn 20 preferably has a twist, and in particular a high twist, so as to readily withstand radial compression and to conserve its round shape when the composite products are being treated. Preferably, the plant fibers of the core 21 of the hybrid yarns 20 are twisted as shown in FIG. 1b, such that the angle formed by the outer fibers of the core 21 with the longitudinal axis of the hybrid yarn 20 is between 10 and 45°, preferably between 12 and 40°, preferably between 15° and 35°.

In this first embodiment, the covering 22 is made up of carbon fibers, the fibers being oriented in the lengthwise direction (main direction) of the hybrid yarn 20 (see FIG. 1c) or forming an angle with the main direction of the hybrid yarn 20 which is less than 15°. This composition of the hybrid yarn 20 has the advantage of having a coating (covering 22) with a high-performance material (second material), with fibers aligned in the loading direction, and a center (core 22) with a material (first material) that is relatively lightweight, inexpensive and has good radial compressive strength. In addition, since the plant fibers such as flax have a coefficient of thermal expansion similar to that of carbon, it is possible to use the hybrid yarn 20 according to the first embodiment over a wide temperature range, without thermal stress and without residual deformation.

Since the hybrid yarns are made up of fibers impregnated by a polymer matrix during the implementation of the composite product, it is necessary to bind the core to the covering in the unimpregnated state of the hybrid yarn. Various possibilities exist for manufacturing such hybrid yarns 20, and in particular for linking the core 21 to the covering 22. The layer of covering 22 may be made by applying one or more strands (or rovings) to the core 21 of the hybrid yarn 20. In this case, in each hybrid yarn 20, the covering 22 is formed by one or more rovings (one or more strands). The strands of the covering 22 may be adhesively bonded to the core 21 of the hybrid yarn, or may be held on the core 21 of the hybrid yarn of the yarn by a small binding yarn 23 helically wound around the hybrid yarn 20 (see FIG. 1c). This binding yarn 23, helically wound around the assembly formed by the core 21 and the covering 22, also makes it possible to maintain the circular cross section of the hybrid yarn 20 during the manufacture and then the use of the composite product.

As an alternative, the strands of the covering 22 may be braided around the core 21 at a very flat angle (small angle of between 5 and 30°). Lastly, if the hybrid yarn 20 is preimpregnated, the two layers (covering 22 and core 21) of the hybrid yarn 20 may be assembled during the impregnation step. For example, for impregnation with a thermosetting matrix, in particular with a resin such as epoxy, the core 21 and the material of the covering 22 are each dipped in an epoxy bath, then assembled during the resin prepolymerization step. This is because the resin remains sticky and soft and is completely polymerized subsequently by curing during the manufacture of the composite part, which allows the matrix to harden. If the composite part or product is manufactured using the thermoplastic impregnation technique, the core 21 and the covering 22 may be assembled in the tool (in particular the molding tool) with the molten polymer and be held together in shape while the polymer cools down. In this way, the resin or the polymer serves as adhesive between the core 21 and the covering 22.

In general, and applicable to all the embodiments of the hybrid yarn 20, in each hybrid yarn 20, said core 21 of the hybrid yarn 20 is connected to said covering 22 of the hybrid yarn 20. Then, once the fibers constituting the hybrid yarn have been impregnated by the organic matrix and after polymerization of the matrix, the matrix provides a bond between the covering and the core. This produces the cohesion between the core and the covering of the hybrid yarn 20.

In order to further improve the radial compressive strength during the treatment, the plant fibers of the core 21 may also be coated with starch or another natural cement prior to their assembly with the covering 22.

According to a second embodiment of the hybrid yarns 20, the material of the core 21 is made up of or includes plant fibers (as in the first embodiment), but the covering 22 is formed by one or more strips of high-quality plant fibers. This or these strip(s) is (are) in the form of (a) roving(s) or (a) strand(s) essentially having long fibers. Thus, the covering of the hybrid yarns is formed by plant fibers in the form of rovings, said rovings being made up of aligned plant fibers forming an angle of less than 5° (between 0° and 5°) with the longitudinal or main direction of the roving, such that the Young's modulus of the roving impregnated with an organic matrix, in the longitudinal direction of the rovings, is greater than 30 GPa, and preferably greater than 32.5 GPa, and preferably greater than 35 GPa. Note that the rovings/strips, forming the covering 22, may have an angle of 0 to 15° between their main direction and the main direction of the hybrid yarn 20.

This solution has the advantage of being entirely plant-based, and uses high-quality fibers solely on the outer layer (covering) of the hybrid yarn, and an inexpensive core of plant fibers, thus offering the best performance/price ratio.

According to a third embodiment, the hybrid yarns 20 have a polymer core 21, said polymer belonging to the group comprising polyurethane (PU), polyethylene terephthalate (PET), polylactic acid (PLA), polyvinyl chloride (PVC), polystyrene (PS), polymethacrylamide (PMI), and styrene-acrylonitrile copolymer (SAN). This polymer may take various forms, including the form of a bulk yarn, a polymer foam yarn or a polymer fiber yarn. This polymer core 21 is for example obtained by extrusion, which makes it possible for example to give it a predefined shape in cross section, for example a circular, elliptical, square or polygonal shape. The covering 22 may be made of carbon fibers, of glass fibers or of plant fibers (for these plant fibers, one from among the following list is preferred: flax, hemp, sisal, jute, abaca, kenaf, nettle, ramie, kapok, abaca, henequen, pineapple, banana plant, palm, and wood fibers). This third embodiment has the advantage of providing a hybrid yarn 20 which has a low density and thus offers a very high performance/weight ratio.

According to a fourth embodiment, shown in FIG. 1d, the core 21 of the hybrid yarns 20 is a hollow, tubular polymer yarn, the wall of which has holes 21a. By way of example, the polymer of the core belongs to the following list: polylactic polymer PLA, polyester PE, polyamide PA, polyvinyl chloride PVC, polystyrene PS, CP (cellulose propionate) or CAP (cellulose acetate propionate), or CAB (cellulose acetate butyrate). This hybrid yarn 20 has the advantage of acting as a flow medium for the vacuum resin infusion molding processes, as the resin is able to flow rapidly through the central passage of the polymer tube forming the core 21 and then to flow through the holes 21a in the wall of the polymer tube forming the core 21 during the infusion, thus impregnating the covering 22 of the hybrid yarn 20 and the adjacent fibers (covering 22 of the adjacent hybrid yarns 20 and the possible adjacent yarns (A) and/or the possible lower layer(s)). It is also the case that, since the internal passage of the polymer tube forming the core 21 and the holes 21a in the walls of the polymer tube are filled with resin, it is possible to establish a mechanical anchoring of the layers that are present around the polymer tube forming the core 21 during the manufacture of the composite product 30.

The covering 22 may be, as in the case of the third embodiment, made of carbon fibers, of glass fibers or of plant fibers.

According to a fifth embodiment, the hybrid yarns 20 comprise a core 21 which is made of aramid fibers, or of drawn fibers of ultra-high molecular polyethylene (UHMPE), or of drawn thermoplastic fibers. By way of example, these fibers are made of Kevlar (registered trade mark), Twaron (registered trade mark), Dyneema (registered trade mark). The hybrid yarns 20 of this fifth embodiment comprise a covering 22 made of carbon fibers, thereby making it possible to contribute strength and stiffness to the hybrid yarn 20. The fibers of the core 21 are preferably twisted or braided together, in order thus to offer good radial compressive strength to the hybrid yarn 20. This fifth embodiment makes it possible to contribute a very high flexural stiffness to the composite products and to the parts using this hybrid yarn 20 as reinforcement, while still having very advantageous performance in the event of a crash. If a reinforcing grid is formed with these hybrid yarns 20 that has a high-tenacity center, the formation of fragments in the event of a crash is as a matter of fact avoided, the high-tenacity fibers keeping all the parts of the structure in a single piece, even if said structure is severely damaged.

The modes of assembly possible between the covering 22 and the core 21 of the hybrid yarns of the second embodiment, of the third embodiment, of the fourth embodiment and of the fifth embodiment are similar to those described above in relation to the first embodiment.

According to one exemplary embodiment, the core 21 of the hybrid yarn 20 is made of flax and the covering 22 of the hybrid yarn 20 is made of carbon fibers.

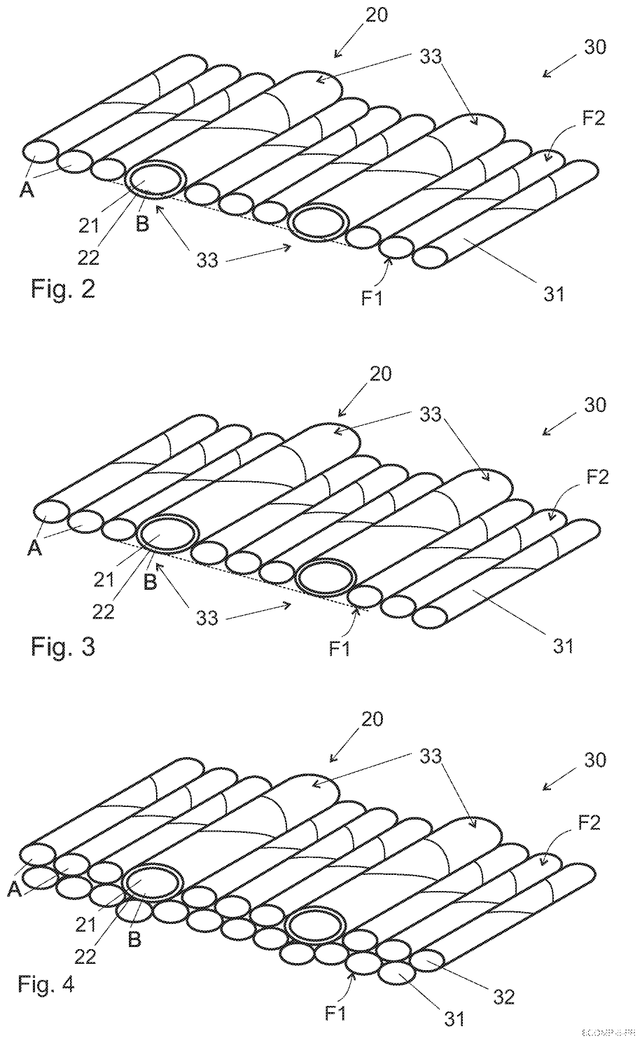

FIGS. 2 to 6 show the diagrams of prepregs in the form of sheets which serve as a basis for the manufacture of composite products according to the invention, incorporating two different diameters of yarns (A) and (B).

Reference is made to FIGS. 2 and 3, which show two variants of a first type of possible arrangement for the composite product 30. In this first type of arrangement, the composite product 30 has at least a first layer 31, said first layer 31 comprising both a first type of yarns (A) having a first thickness and a second type of yarns (B) having a second thickness greater than the first thickness, said second type of yarns (B) being made up of hybrid yarns 20 as described above. In the case shown in FIGS. 2 and 3, the composite product 30 has a sole, single layer of yarn formed by the first layer 31 but, in cases which are not shown, the composite product 30 may have this first layer 31 and one other layer or multiple other layers in a stack with this first layer 31.

In the variants of FIGS. 2 and 3, the thicker yarns B are sewn into the same first layer 31 of yarns as the thinner yarns A, all the yarns A and B being parallel to one another, while it is possible for the order in which the thicker yarns B are placed to repeat regularly or to not repeat regularly.

In the variant of FIG. 2, this first layer 31 has two faces F1 and F2 which are not planar since, because the hybrid yarns B are thicker than the yarns A, they form ribs 33 on the two faces.

In the variant of FIG. 3, the composite product 30 comprises a single layer 31 with yarns A that have a first diameter and second yarns B that have a larger diameter and are formed by hybrid yarns 20; however, one of the two faces (the face F1, which is the lower face in this example) comprises the yarns A and B which are flush with one another, this resulting in a planar surface for the face F1. This planar face F1 may be obtained for example by pressing the prepreg in the form of a sheet against the planar face of a mold. The other face F2 of this layer 31 (the upper face in this example) comprises ribs 33 resulting from the yarns B or hybrid yarns.

Reference is made to FIGS. 4 to 7, which show three variants of a second type of possible arrangement for the composite product 30. In this second type of arrangement, the composite product 30 has at least a first layer 31 of yarns having a first thickness, and a second layer 32 of yarns overlaying the first layer 31, said yarns of the second layer 32 comprising hybrid yarns 20 as described above, the hybrid yarns 20 being spaced apart from one another in order to create a ribbed surface for the composite product 30 in that the ribs 33 arise from the overthickness generated by the hybrid yarns 20 (yarns B) on the opposite face F2 of the composite product 30 to that (face F1) carrying the first layer 31.

In the first variant of FIG. 4, the composite product 30 comprises a first layer 31 of parallel thin yarns A that adjoin one another in pairs. This first layer 31 is superimposed on or under a non-planar face of a second layer 32 configured as the single layer of the composite product 30 of FIG. 2, thereby resulting in a composite product 30 with at least one side which is non-flat and which forms ribs 33 (face F2). In the particular case of FIG. 4, the composite product 30 has two faces (F1 and F2) with ribs 33 at the location of the yarns B or hybrid yarns. The first layer 31 is preferably made up of yarns A all having the same diameter; it may be sewn onto the second layer 32, or adhesively bonded with resin or with the polymer of the composite product 30.

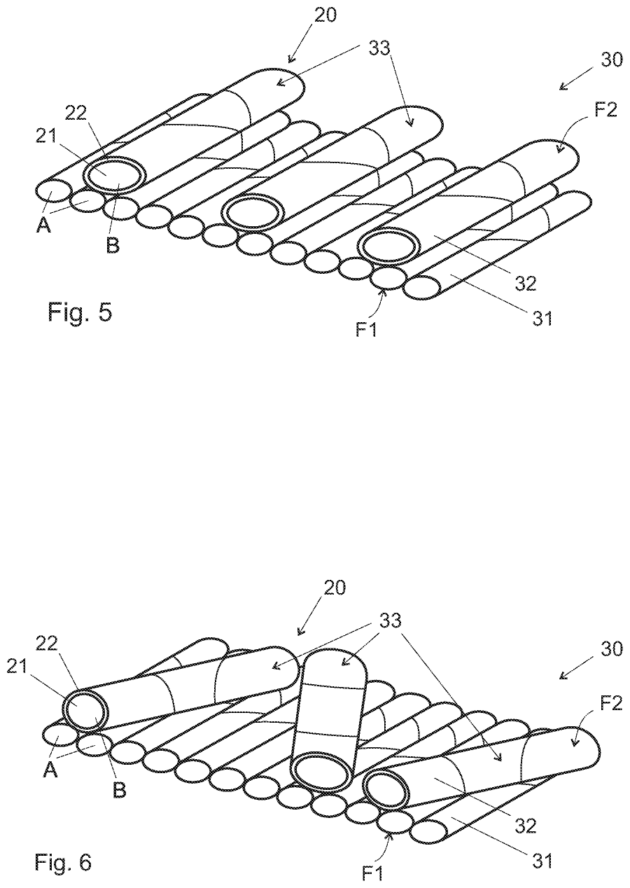

In the second variant of FIG. 5, the composite product 30 comprises spaced-apart thick yarns B formed by hybrid yarns 20 and constituting a second layer 32, which are sewn (or held in place by other techniques, e.g. adhesively bonded, adhesively bonded or obtained directly by weaving, knitting, braiding or any other known textile manufacturing process) onto a first layer 31 of densely aligned thinner yarns A (all the yarns A are parallel to one another and in contact with the two neighboring yarns A). The second layer 32 (upper layer in FIG. 5) may be made of yarns B, the thickness of which is equal to or greater than that of the yarns A of the first layer 31 (base layer formed by a lower layer in FIG. 5, and which defines a planar face F1), the second layer 32 defining a face F2 of the composite product 30 with ribs 33. In addition to the diameter of the yarn, the fibers used in each of the yarns A and B may differ, for example by using one type of fibers in the thin yarns A and a second type of fibers in the thicker yarns B, specifically in the core 21 and/or the covering 22 of these yarns B. The angle between the yarns B of the second layer 32 may also vary (angle of 0° for mutually parallel yarns B in FIG. 5).

In the first variant shown in FIG. 4 and in the second variant shown in FIG. 5, the yarns B of the second layer 32 are parallel to the yarns A of the first layer 31, and in the third variant of FIG. 6, the yarns B of the second layer 32 are not parallel to the yarns A of the first layer 31 but intersect with the direction of the yarns A of the first layer 31. The angle between the yarns B of the second layer 32 and the yarns A of the first layer 31 may vary from a few degrees (2 or 3)° (yarns B substantially parallel to the yarns A of the first layer 31) to 90° (yarns B perpendicular to the yarns A of the first layer 31). Likewise, in the case of FIG. 6, the yarns B of the second layer 32 intersect one another, while still intersecting with the direction of the yarns of the first layer 31. In addition, it is possible to have a preform in the form of a sheet comprising yarns having more than two different diameters and/or more than two types, and/or more than two angles.

These woven fabrics or preform in the form of a sheet may be obtained in a single step by using yarns having one thickness or different thicknesses in conjunction with textile manufacturing equipment, by transforming said yarns so as to obtain the final textile architecture, in which some of the yarns are placed so as to construct the ribs 33 once the textile has been transformed to form the final composite part or a composite product. As an alternative, one type of yarns or a grid of yarns (comprising or constituting hybrid yarns 20) is placed on a standard weave, a woven fabric or non-woven fabric made up of the same type or a different type of yarns, or a mat of fibers, which forms a first support layer obtained in a preceding step. Other methods may be used to obtain these woven fabrics, such as weaving, knitting, braiding and sewing for manufacturing woven fabrics or nonwoven fabrics. As an alternative, the yarns may be held together by a polymer, either a thermosetting resin hardened in the subsequent process step, or a polymer dissolved or melted prior to the impregnation of the woven fabric or more generally of the first support layer.

In the case of the first layer 31 of FIG. 2 or the second layer 32 of FIG. 4, which has both hybrid yarns 20 (yarns B) and other yarns having a smaller thickness (yarns B), many examples of yarn sequences are possible, such as AAABAAAAABAAA, AABAABAAA, AABAABAA, ABABABABA, AAAABAABAAAA, AABAACAABAAC, in which A, B and C are various yarn diameters and the yarn B is a hybrid yarn 20, and wherein these sequences may repeat as often as is necessary to meet the specific needs of the final part, and wherein any imaginable sequence of at least two different diameters is included in the present invention. Beyond these examples, other types of combinations, including non-repeating sequences, combinations of the above sequences or combinations of more than two different yarn types may be used. In addition to the thickness, the type of fibers may also vary from one type of yarn to the other.

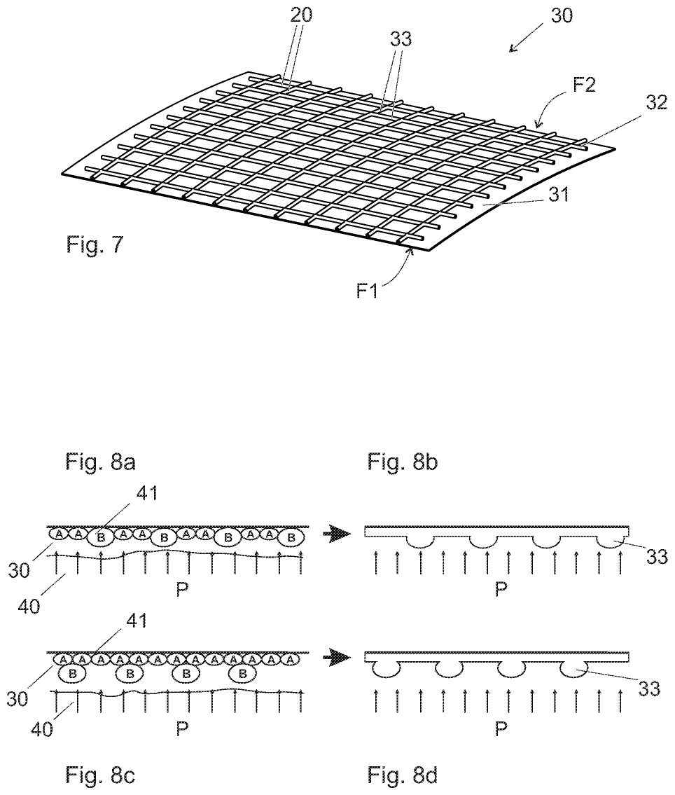

If reference is made to FIG. 7, a composite product 30 has a first layer 31 superimposed with a second layer 32 forming a grid of hybrid yarns 20. More specifically, this second layer 32 has hybrid yarns 20 distributed between a first series of mutually parallel hybrid yarns 20 and a second series of mutually parallel hybrid yarns 20, the direction of the first series forming with the direction of the second series an angle of between 30° and 90° so as to form a mesh grid in the shape of a quadrilateral (90° in FIG. 7, where the second layer 32 is a rectangular mesh grid of hybrid yarns 20).

In the case of FIG. 7, but also in the case of the arrangements of FIGS. 4 to 6, the first layer 31 belongs for example to the group comprising a woven fabric (in particular a woven fabric of flax yarns, or of carbon fibers) or a mat of plant fibers, of carbon fibers, of glass fibers or of polymer fibers, a metal sheet, an aluminum sheet, and a polymer sheet.

It is apparent from the above that the hybrid yarns 20 (yarns B) are possibly disposed in the first layer 31 or in the second layer 32 parallel to one another in a single direction or else in only two directions, or else in only three directions or else in only four directions.

According to one possible disposition, the hybrid yarn 20 is present in the composite product 30 to at least 5% by weight of parallel reinforcement or at least 10% by weight of intersecting reinforcement.

According to one possible disposition, corresponding to the arrangements of FIGS. 3, 5, 6 and 7, the composite product 30 has a ribbed face and a planar face.

FIG. 8 shows an illustration of the treatment and consolidation steps in the case of a composite product 30 with a planar surface (having a single layer in FIGS. 8a and 8b, and having two layers in FIGS. 8c and 8d). The preform 30 is pressed against a stiff mold 41. When the yarns A and B of the preform 30 form a dry woven fabric, impregnation with a thermoplastic resin or thermosetting resin is initiated and carried out before, during or just after the increase in pressure. The pressure may be applied using a flexible membrane 40 or a flexible pad (which does not need to be an inflatable bladder, although it may be) on one side and applying a pressure P to this flexible membrane 40 (FIGS. 8a and 8c). The flexible membrane 40 adapts to the woven fabric of variable thickness. The temperature of the mold 41 is then increased so as to (i) reduce the viscosity of the polymer and optimize the impregnation of the fibers, and (ii) consolidate the part by crosslinking the thermoset resin. In the case of a thermoplastic matrix, consolidation occurs after heating when the temperature is reduced to a temperature below the glass transition temperature of the polymer. The method may also be applied to singly curved or doubly curved surfaces. The composite product obtained (FIGS. 8b and 8d) has ribs 33 at the location of the hybrid yarns 20 (yarns B).

In the case of flat or curved shapes, the two sides of the mold 41 may be stiff (metallic, for example), with one surface of the mold 41 containing grooves machined in the surface, corresponding to the negative of the corresponding yarns B (or yarns A and B) placed on the surface of the composite preform 30. The grooves in the mold 41 then serve as guides for accurately placing the preform in the mold 40, before the mold is closed and the composite hardens as described above.

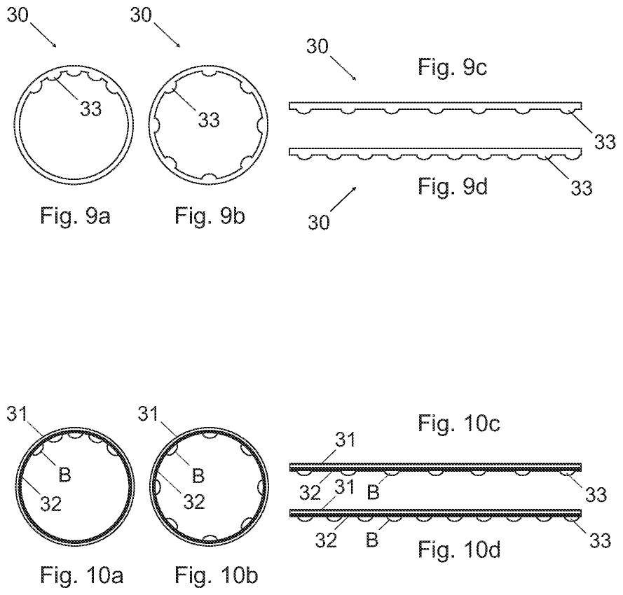

Examples of composite products 30, in the form of composite-fiber tubes and sheets obtained from the technology presented are shown in FIGS. 9a to 9d. The stiffeners resulting from the ribs 33 may be either (FIG. 9a) placed locally in some parts of the tube section, or (FIG. 9b) placed evenly around the circumference of the tube section, depending on the structural needs and stiffness requirements of the final part. Examples of various densities of stiffeners resulting from the ribs 33 in the flat sheets are given in FIGS. 9c and 9d. Factors such as the space between the ribs 33, the regularity of the sequence of the ribs 33, the type of fibers used in the ribs 33, their orientation and their thickness may be applied to all the shapes, including the hollow parts with a closed cross section, the flat sheets and the singly or doubly curved surfaces. In addition, the ribs 33 can function at any angle and may also intersect if multiple directions need to be reinforced. A specific example of the latter is a tube with stiffeners extending at ±45° in relation to the longitudinal axis, for the purpose of increasing the resistance to buckling and collapse of the section. All of the possible variables, specifically the regularity of the sequence of the ribs 33, the distribution of the ribs 33, the type(s) of fibers used in the ribs 33, their thickness or even their angle, may be applied to all of the shapes, including the tubes, the flat sheets and the singly or doubly curved surfaces.

FIG. 10 shows examples of composite-material tubes and sheets obtained from the technology disclosed in the present application, which combine at least two different types of fibrous materials. In FIGS. 10a and 10b, the tubes are composed of a stack of layers with a first layer 31 on the outside, and a different material formed by a second layer 32 on the inside of the tube, while the ribs 33 of the second layer are on the internal face of the tubes. The same applies for flat sheets (FIGS. 10c and 10d), or for any other singly or doubly curved surface. This approach may be used for composite parts with high damping requirements. The outside of the tube may then be made of a material with a significantly higher storage modulus E′ than the storage modulus of the second layer 32, which has by contrast a significantly higher loss modulus E′″ (and therefore damping capacity) in relation to the material of the external layer 31.

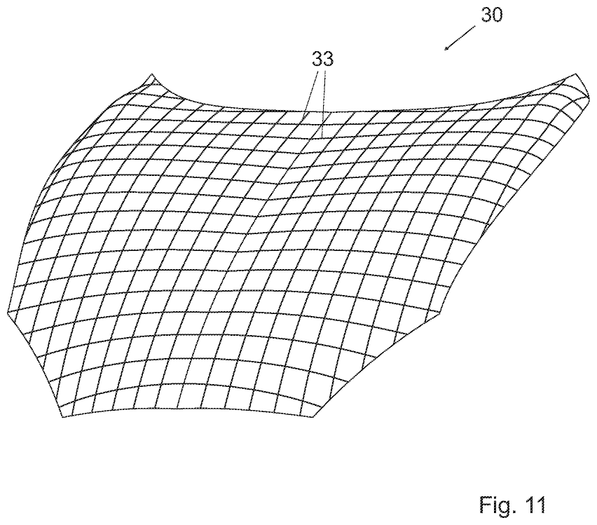

FIG. 11 illustrates one embodiment of a product according to the invention. The composite product 30 in this example is a sports car hood. A sports car hood mainly has to withstand flexural loading resulting from aerodynamic pressures at high speed and should be as lightweight as possible. It is also the case that only the outer face of the hood, when said hood is mounted on a vehicle, needs to be smooth.

Using the technology disclosed, it is possible to design a sports car hood that exhibits an optimum weight/performance ratio and is made of a composite product 30 using, for example, natural fibers and carbon fibers. According to one possibility, the upper layer of the sheet is made up of a laminate (multiple laminate layers) with layers of fibers oriented at 0°, ±45° and 90° to the axis. The ribs 33 placed on the concave side of the sheet are oriented at 0° and 90° so as to withstand flexural loading owing to the surface pressure (these ribs 33 are placed on the rear face of the sheet in the view of FIG. 11, and are therefore seen in transparency in this FIG. 11).

A diagram of the design is illustrated in FIG. 11. The composite is preferably composed for the one part of a combination of flax fibers and carbon fibers and for the other part either of a thermosetting resin (such as epoxy), or of a thermoplastic polymer such as poly(lactic acid) (PLA), poly(propylene) (PP), or any type of poly(amide) (PA). The thickness of the outer wall (first layer 31) and/or of the ribs 33 on the inside varies between 0.5 and 3 mm.

The sports car hood designed with the aid of the present invention offers an optimum combination for a structural design with a minimum amount of material (and therefore weight).

As an alternative, the sports car hood may be produced using, as the hybrid yarn, a core 21 and a covering 22 both made only of flax fibers in different shapes, which constitutes a first material for the core 21, and a second material, different than the first material, for the covering 22: for example the first material is formed by short flax fibers treated so as to form a yarn with a significant twist (the angle between the outer fibers of the yarn and the axis of the yarn is preferably between 10° and 45°, preferably between 12° and 40°, and preferably between 15° and 35°, including these limit values, and according to one possibility this angle is greater than or equal to 15°) and the second material is formed by long flax fibers in the form of rovings. In this case, by using hybrid yarns solely made of plant fibers in the core 21 and the covering 22, optimum performance is obtained while still making use of biobased materials.

### REFERENCE NUMBERS EMPLOYED IN THE FIGURES

20 Hybrid yarn
21 Core
21a Holes
22 Covering
23 Binding yarn
30 Composite product
31 First layer
32 Second layer
33 Ribs
40 Flexible membrane
41 Mold
F1 Face of the composite product
F2 Face of the composite product

1. A yarn-reinforced, thin-walled composite product with an organic matrix, the yarns including hybrid yarns, said hybrid yarns having a core made from a first material having a density of less than 1500 kg/m3 and a covering that overlays the core, the covering being made from a second material, said second material being different than the first material and having a longitudinal Young's modulus of greater than 25 GPa, and said product having at least one ribbed face, said ribs being created at least in part by the hybrid yarns.

2. The composite product reinforced by hybrid yarns as claimed in claim 1, having at least a first layer, said first layer comprising both a first type of yarns (A) having a first thickness and a second type of yarns (B) having a second thickness greater than the first thickness, said second type of yarns (B) being made up of said hybrid yarns.

3. The composite product reinforced by hybrid yarns as claimed in claim 1, having at least a first layer having a first thickness, said first layer being overlaid with a second layer of yarns, said yarns of the second layer comprising said hybrid yarns, the hybrid yarns being spaced apart so as to create a ribbed surface.

4. The composite product as claimed in claim 3, wherein said hybrid yarns are disposed in the second layer parallel to one another in a single direction or else in only two, three or four directions.

5. The composite product as claimed in claim 3, wherein said hybrid yarns have a second thickness greater than the first thickness of the first layer.

6. The composite product as claimed in claim 1, characterized in that it has a ribbed face and a planar face.

7. The composite product as claimed in claim 1, characterized in that in each hybrid yarn, said covering is formed by one or more rovings.

8. The composite product as claimed in claim 1, characterized in that in each hybrid yarn, said core of the hybrid yarn is connected to said covering of the hybrid yarn.

9. The composite product as claimed in claim 8, wherein the core of the hybrid yarns is formed by plant fibers from among the fibers of the following plants: flax, hemp, sisal, jute, abaca, kenaf, coconut, cotton, nettle, ramie, kapok, abaca, henequen, pineapple, banana plant, palm, wood.

10. The composite product as claimed in claim 9, wherein the plant fibers of the core of the hybrid yarns are twisted, such that the angle formed by the outer fibers of the core with the longitudinal axis of the hybrid yarn is between 10 and 45°, preferably between 12 and 40°, preferably between 15° and 35°.

11. The composite product as claimed in claim 9, wherein the plant fibers of the core of the hybrid yarns are coated with starch or another natural cement.

12. The composite product as claimed in claim 9, wherein the covering of the hybrid yarns is formed by carbon fibers.

13. The composite product as claimed in claim 9, wherein the covering of the hybrid yarns is formed by plant fibers in the form of rovings, said rovings being made up of aligned plant fibers forming an angle of less than 5° with the longitudinal direction of the roving, such that the Young's modulus, in the longitudinal direction of the rovings, of the roving impregnated with an organic matrix is greater than 30 GPa.

14. The composite product as claimed in claim 1, characterized in that the core of the hybrid yarns is made of a polymer, said polymer belonging to the group comprising polyurethane (PU), polyethylene terephthalate (PET), polylactic acid (PLA), polyvinyl chloride (PVC), polystyrene (PS), polymethacrylamide (PMI), and styrene-acrylonitrile copolymer (SAN).

15. The composite product as claimed in claim 14, characterized in that the core is a hollow, tubular polymer yarn, the wall of which has holes (21a).

16. The composite product as claimed in claim 14, characterized in that the covering of the hybrid yarns is made of carbon fibers, glass fibers or plant fibers.

17. The composite product as claimed in claim 1, characterized in that the core is made of aramid fibers, or of drawn fibers of an ultra-high molecular polyethylene (UHMPE), or of drawn thermoplastic fibers.

18. The composite product as claimed in claim 17, characterized in that the covering of the hybrid yarns is made of carbon fibers.

19. The composite product as claimed in claim 17, characterized in that the fibers of the core are twisted or braided together.

20. The composite product as claimed in claim 3, characterized in that said first layer belongs to the group comprising a woven fabric or a mat of plant fibers, of carbon fibers, of glass fibers or of polymer fibers, a metal sheet, an aluminum sheet, and a polymer sheet.

21. The composite product as claimed in claim 1, characterized in that the core is made of flax and the covering is made of carbon fibers.

22. The composite product as claimed in claim 1, in that said hybrid yarn is present to at least 5% by weight of parallel reinforcement or at least 10% by weight of intersecting reinforcement.

23. The composite product as claimed in claim 1, characterized in that it forms a three-dimensional shell or sheet.

24. A method for manufacturing a composite product having an organic matrix, wherein the following steps are implemented:
manufacturing a preform comprising yarns, said yarns including hybrid yarns, said hybrid yarns having a core made from a first material and a covering that overlays the core, the covering being made from a second material, said second material being different than the first material,
impregnating said preform with an organic matrix,
applying pressure by way of a membrane or a flexible pad to a raised side of the preform against a mold,
controlling the temperature of the mold so as to solidify said organic matrix, so as to obtain a solidified product in which at least one external face forms ribs created at least in part by said hybrid yarns, wherein said first material has a density of less than 1500 kg/m³, and wherein said second material has a longitudinal Young's modulus of greater than 25 GPa.
